(19) United States
(12) Patent Application Publication
(10) Pub. No.: US 2020/0313939 A1
(43) Pub. Date: Oct. 1, 2020

(54) SYSTEM, NETWORK NODE, WIRELESS DEVICE, METHOD AND COMPUTER PROGRAM FOR LOW-POWER BACKSCATTERING OPERATION

(71) Applicant: Telefonaktiebolaget LM Ericsson (publ), Stockholm (SE)

(72) Inventors: Miguel Lopez, Solna (SE); Leif WILHELMSSON, Lund (SE)

(21) Appl. No.: 16/772,906

(22) PCT Filed: Dec. 22, 2017
(86) PCT No.: PCT/EP2017/084531

§ 371 Date: Jun. 15, 2020

(51) Int. Cl. H04L 27/00; H04W 52/02; H04W 74/08

(52) U.S. Cl. CPC H04L 27/0008; H04L 27/0006; H04W 74/0808; H04W 52/0229

(57) ABSTRACT

A system comprises a network node, a wireless device, and a receiving device. The network node is arranged to support the wireless device. The wireless device is arranged for passive or semi-passive radio transmissions. The network node is arranged to provide a radio frequency, RF, signal towards the wireless device. The RF signal comprises a first part and a second part. The first part is configured for being purely retransmitted by backscattering by the wireless device. The second part is configured for backscattering keying by the wireless device to convey data from the wireless device to the receiving device. Methods and computer programs for the network node and the wireless device are disclosed.

### TECHNICAL FIELD

The present invention generally relates to a system for backscattering communication, a network node, a wireless device, and methods and computer programs therefor. In particular, the present invention relates to letting the network node aid the wireless device to enable low-power operation of the wireless device.

### BACKGROUND

Semi-passive and passive transmitters have been used in various applications. Passive transmitters are powered entirely by the energy received from an incoming RF signal. Semi-passive transmitters have a battery and consume power to perform baseband processing, but lack a power amplifier and many other components present in a transmitter RF signal chain. Thus, both passive and semi-passive transmitters are power efficient.

FIG. 1 schematically illustrates a radio frequency (RF) generator 100 operating as a radiating device providing the RF signal 102 such that it reaches a wireless device 104 arranged to operate as a passive or semi-passive transmitter, which retransmits, using the incoming energy from the RF signal 102, a signal 108 towards a receiver 106. The retransmission is for example performed by, as illustrated in FIG. 2, an antenna arrangement 200 selectable connected via a switching arrangement 202 to a plurality of impedances 204. The switching arrangement 202 is controlled by a baseband signal provided by a baseband signal generator 206. Depending on the selected impedance, a phase shift is provided for the reflected signal 108. Thus, the wireless device 104 is enabled to transmit information which the baseband signal generator 206 by the switching of the impedances 204 can modulate the retransmitted signal 108.

The main idea with the semi-passive and passive transmitters is to delegate the generation of RF carriers to an external node that is mains powered. This implies that no power-hungry power amplifiers, filters, mixers and other components are needed in the semi- or passive device. The semi-passive or passive devices generate transmitting signals by using an antenna mismatched to the incoming RF carrier signal, thus reflecting or backscattering the incoming radio waves, and by modulating the reflected electromagnetic waves in order to transmit data to a receiving unit.

Passive and semi-passive devices have good potential in Internet of Things (IoT) applications, due to their power efficiency. For example, in Kellog. et al, “Passive WiFi: Bringing Low Power to Wi-Fi Transmissions”, University of Washington, it is shown how to implement a power efficient semi-passive device compliant with the IEEE 802.11b standard. In Ensworth J. F., Reynolds M. S., “Every smart phone is a backscatter reader: Modulated backscatter compatibility with Bluetooth 4.0 Low Energy (BLE) devices”, Radio Frequency Identification (RFID), 2015 IEEE International Conference, 15-17 Apr. 2015, it is shown how to modify passive RFID tags so that the reflected signal can be received by ordinary off-the-shelf Bluetooth Low Energy (BLE) receivers.

A problem with passive and semi-passive generation of RF signals by means of backscattering is that the power of the reflected waves is usually quite small. This is especially an issue in unlicensed bands, where the RF tone generator has a transmitting power limited by regulations targeting short range devices, i.e. equivalent isotropically radiated power (EIRP) is limited to 30 dBm or less, depending on the region. Hence, the range of the passive/semi-passive devices is quite limited. This limits the usability of these type of devices.

As an example, if the RF generator is located at a distance of 5 meters from the semi-passive device and has a transmitting power of 14 dBm, then the backscattered power is approximately −42 dBm. As a comparison, the BLE specification ensures that BLE devices have a transmitting power varying between −20 dBm and +10 dBm.

One way of avoiding self-induced interference by the system is that the radiating entity 100, which provides the incoming RF signal 102 towards the backscattering device 104, provides the signal towards the backscattering device 104 at first frequency and by the switching of the backscattering device 104 make the retransmitted signal occur on another frequency or frequencies, e.g. as illustrated in FIG. 3 where the upper diagram illustrates a power to frequency diagram for the RF signal 102 and the lower diagram illustrates a power to frequency diagram for the retransmitted signal 108.

FIG. 4 illustrates a diagram corresponding to FIG. 3 but where a switching approach is used where the RF signal 102 is retransmitted on the same frequency. The upper diagram illustrates a power to frequency diagram for the RF signal 102 and the lower diagram illustrates a power to frequency diagram for the retransmitted signal 108.

One way of avoiding self-induced interference by the system is that the radiating entity 100, which provides the incoming RF signal 102 towards the backscattering device 104, provides the signal towards the backscattering device 104 while limiting the signal in other directions, particularly in the direction of a receiver 106 of the backscattered signal 108. Although the above demonstrated approaches of limiting radiating signal 102 towards entities 106 participating in the communication or separating the frequencies of the signals 102 and 108 are beneficial, it also implies an issue when used in a radio environment employing listen-before-talk, LBT, i.e. that an entity desiring to transmit first need to assess whether the channel is clear to use and not used by other entities. Kellog et al referred to above provides in section 3 some teaching about use in a band requiring LBT, and suggests that the radiating entity should apply carrier sense, relieving the backscattering device from this, to see if the channel is free to use. However, the LBT works in the other way as well. Thus, other devices need to be able to consider the backscattered signal, when being provided, to determine if the channel is free. It is therefore desired to enable the backscattering device, with its limited capabilities in sense of power, processing, etc., to keep the channel occupied to be able to transmit, i.e. reflect, its message. For example, Wi-Fi devices perform LBT in two ways, called energy detection and preamble detection. The detection thresholds are different, typical values being −62 dBm for energy detection and −82 dBm for preamble detection. If a backscattering device could reflect a signal such that nearby Wi-Fi devices could detect it via preamble detection, said signal would be much less likely to be interfered by the Wi-Fi devices than an arbitrary signal that can only be detected via energy detection, due to the 20 dB difference in the value of the detection thresholds.

### SUMMARY

The invention is based on the inventors' understanding that the low-power device needs to provide a recognised signal to indicate that the channel is occupied such that it can make its transmission without being interfered by nearby devices, but the nature of the low-power device limits its ability to accomplish that. The inventors have thus suggested an approach to enable the low-power device to do this and keep its low-power characteristics.

According to a first aspect, there is provided a system comprising a network node, a wireless device, and a receiving device. The network node is arranged to support the wireless device. The wireless device is arranged for passive or semi-passive radio transmissions. The network node is arranged to provide a radio frequency, RF, signal towards the wireless device, wherein the RF signal comprises a first part and a second part. The first part is configured for being purely retransmitted by backscattering by the wireless device. The second part is configured for backscattering keying by the wireless device to convey data from the wireless device to the receiving device.

The network node may be arranged to perform clear channel assessment, CCA, on behalf of the wireless device and, upon a clear channel, provide the radio frequency, RF, signal towards the wireless device.

The first part may be configured for keeping channel protected in view of clear channel assessment, CCA, by other entities by enabling decoding of the first part by the other entities. The first part may comprise orthogonal frequency division multiplex, OFDM, symbols and the backscattered second part comprises symbols keyed with lower complexity enabled by the backscattering keying. The symbols keyed with the lower complexity may be keyed with any one of on-off keying, amplitude shift keying, frequency shift keying, and phase shift keying.

The first part may comprise one or more of a preamble, a midamble, a postamble, reference signals, and synchronisation signals.

The first part may be distributed over a duration of the RF signal and the second part is interspersed with the first part. Alternatively, the first part may be provided at an uninterrupted part of the RF signal and the second part is provided over a rest of a duration of the RF signal.

The RF signal may be transmitted at a first frequency on which the wireless device is expected to perform its transmissions towards the receiving device. The network node may be arranged to direct the RF signal towards the wireless device and attenuate the RF signal towards the receiving device.

The wireless device may be expected to perform its transmissions towards the receiving device at a first frequency, and the network node may be arranged to transmit the RF signal at a second frequency with an offset defined by the backscattering by the wireless device to the first frequency.

The first part may further be configured for including transmission parameters on behalf of the wireless device. The transmission parameters may comprise any of control field, address information, and duration of transmission.

According to a second aspect, there is provided a network node arranged to support a wireless device, which wireless device is arranged for passive or semi-passive radio transmissions, and to provide a radio frequency, RF, signal towards the wireless device. The RF signal comprises a first part and a second part, where the first part is configured for being purely retransmitted by backscattering by the wireless device, and the second part is configured for backscattering keying by the wireless device to convey data from the wireless device.

The network node may further be arranged to perform clear channel assessment, CCA, on behalf of the wireless device and, upon a clear channel, provide the radio frequency, RF, signal towards the wireless device.

The first part may be configured for keeping channel protected in view of clear channel assessment, CCA by other entities by enabling decoding of the retransmitted first part by the other entities. The first part may comprise orthogonal frequency division multiplex, OFDM, symbols.

The first part may comprise one or more of a preamble, a midamble, a postamble, reference signals, and synchronisation signals.

The first part may be distributed over a duration of the RF signal and the second part is interspersed with the first part. Alternatively, the first part may be provided at an uninterrupted part of the RF signal and the second part is provided over a rest of a duration of the RF signal.

The RF signal may be transmitted at a first frequency on which the wireless device is expected to perform its transmissions towards a receiver. The network node may be arranged to direct the RF signal towards the wireless device and attenuate the RF signal towards the receiver.

The wireless device may be expected to perform its transmissions towards a receiver at a first frequency, and the network node may be arranged to transmit the RF signal at a second frequency with an offset defined by the backscattering by the wireless device to the first frequency.

The first part may further be configured for including transmission parameters on behalf of the wireless device. The transmission parameters may comprise any of control field, address information, and duration of transmission.

According to a third aspect, there is provided a method of a network node arranged to support a wireless device, which wireless device is arranged for passive or semi-passive radio transmissions. The method comprises preparing a radio frequency, RF, signal which comprises a first part and a second part, where the first part is configured for being purely retransmitted by backscattering by the wireless device, and the second part is configured for backscattering keying by the wireless device to convey data from the wireless device, and transmitting the radio frequency, RF, signal towards the wireless device.

The method may comprise performing clear channel assessment, CCA, on behalf of the wireless device, and upon a clear channel, enabling the transmitting of the radio frequency, RF, signal towards the wireless device.

The first part may be configured for keeping channel protected in view of clear channel assessment, CCA by other entities by enabling decoding of the retransmitted first part by the other entities. The first part may comprise orthogonal frequency division multiplex, OFDM, symbols.

The RF signal may be transmitted at a first frequency on which the wireless device is expected to perform its transmissions towards a receiver, wherein the method may comprise directing the RF signal towards the wireless device, and attenuating the RF signal towards the receiver.

The first part may further be configured for including transmission parameters on behalf of the wireless device. The transmission parameters may comprise any of control field, address information, and duration of transmission.

According to a fourth aspect, there is provided a computer program comprising instructions which, when executed on a processor of a network node, causes the network node to perform the method according to the third aspect.

According to a fifth aspect, there is provided a wireless device arranged for passive or semi-passive radio transmissions by backscattering an incoming radio frequency, RF, signal, which RF signal comprises a first part and a second part, where wireless device is arranged to purely retransmit the first part by backscattering, and configured to key backscattering of the second part to convey data from the wireless device.

The first part may be configured for keeping channel protected in view of clear channel assessment, CCA, by other entities by enabling decoding of the first part by the other entities. The retransmitted first part may comprise orthogonal frequency division multiplex, OFDM, symbols and the backscattered second part may comprise symbols keyed with lower complexity enabled by the backscattering keying. The symbols keyed with the lower complexity may be keyed with any one of on-off keying, amplitude shift keying, frequency shift keying and phase shift keying.

The first part may comprise one or more of a preamble, a midamble, a postamble, reference signals, and synchronisation signals, wherein the wireless device is arranged to adapt timing of the keying of the second part based on any of the signals of the first part.

The first part may be distributed over a duration of the RF signal and the second part may be interspersed with the first part. Alternatively, the first part may be provided at an uninterrupted part of the RF signal and the second part may be provided over a rest of a duration of the RF signal.

The RF signal may be transmitted at a first frequency on which the wireless device is expected to perform its transmissions towards a receiver, wherein the wireless device may be arranged to keep impedances for the backscattering constant during the first part.

The wireless device may be expected to perform its transmissions towards a receiver at a first frequency, and the RF signal has a second frequency with an offset to the first frequency, wherein the wireless device may be arranged to switch impedances for the backscattering with a third frequency to achieve retransmission at the first frequency.

The first part may further be configured for including transmission parameters on behalf of the wireless device. The transmission parameters may comprise any of control field, address information, and duration of transmission.

According to a sixth aspect, there is provided a method of a wireless device arranged for passive or semi-passive radio transmissions by backscattering an incoming radio frequency, RF, signal, which RF signal comprises a first part and a second part. The method comprises purely retransmitting the first part by backscattering, and keying and transmitting by backscattering the second part.

The retransmitted first part may be configured for keeping channel protected in view of clear channel assessment, CCA, by other entities by enabling decoding of the first part by the other entities. The retransmitted first part may comprise orthogonal frequency division multiplex, OFDM, symbols and the backscattered second part may comprise symbols keyed with lower complexity enabled by the backscattering keying. The symbols keyed with the lower complexity may be keyed with any one of on-off keying, amplitude shift keying, frequency shift keying, and phase shift keying.

The RF signal may be at a first frequency on which the wireless device is expected to perform its transmissions towards a receiver, wherein the method may comprise keeping impedances for the backscattering constant during the first part.

The wireless device may be expected to perform its transmissions towards a receiver at a first frequency, and the RF signal has a second frequency with an offset to the first frequency, wherein the method may comprise switching impedances for the backscattering with a third frequency to achieve retransmission at the first frequency.

The first part may further be configured for including transmission parameters on behalf of the wireless device. The transmission parameters may comprise any of control field, address information, and duration of transmission.

According to a seventh aspect, there is provided a computer program comprising instructions which, when executed on a processor of a wireless device, causes the wireless device to perform the method according to the sixth aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 schematically illustrates a radio frequency (RF) generator operating as a radiating device providing the RF signal such that it reaches a wireless device arranged to operate as a passive or semi-passive transmitter.

FIG. 2 schematically illustrates a backscattering device according to an example.

FIG. 3 is a power to frequency diagram for the RF signal and the retransmitted signal according to an example.

FIG. 4 is a power to frequency diagram for the RF signal and the retransmitted signal according to an example.

FIG. 5 schematically illustrates an RF generator operating as a radiating device providing the RF signal such that it reaches a wireless device arranged to operate as a passive or semi-passive transmitter according to an example.

FIG. 6 schematically illustrates an RF generator operating as a radiating device providing the RF signal such that it reaches a wireless device arranged to operate as a passive or semi-passive transmitter according to an example.

FIG. 7 is a timing and signal diagram for the RF generator and the wireless device.

FIGS. 8 to 11 are signal timing diagrams which illustrate transmissions according to different embodiments.

FIG. 12 is a flow chart illustrating a method for a network node according to an embodiment.

FIG. 13 is a block diagram schematically illustrating a network node according to an embodiment.

FIG. 14 schematically illustrates a computer-readable medium and a processing device.

FIG. 15 is a flow chart illustrating a method for a wireless device according to an embodiment.

FIG. 16 is a block diagram schematically illustrating a wireless device according to an embodiment.

FIG. 17 schematically illustrates a computer-readable medium and a processing device.

### DETAILED DESCRIPTION

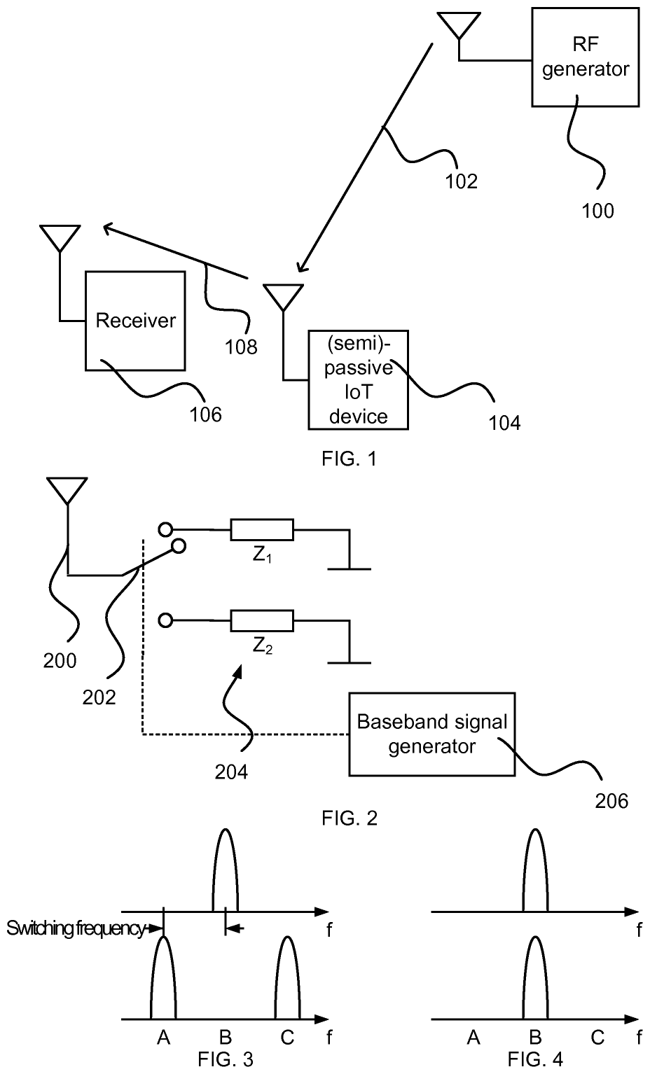

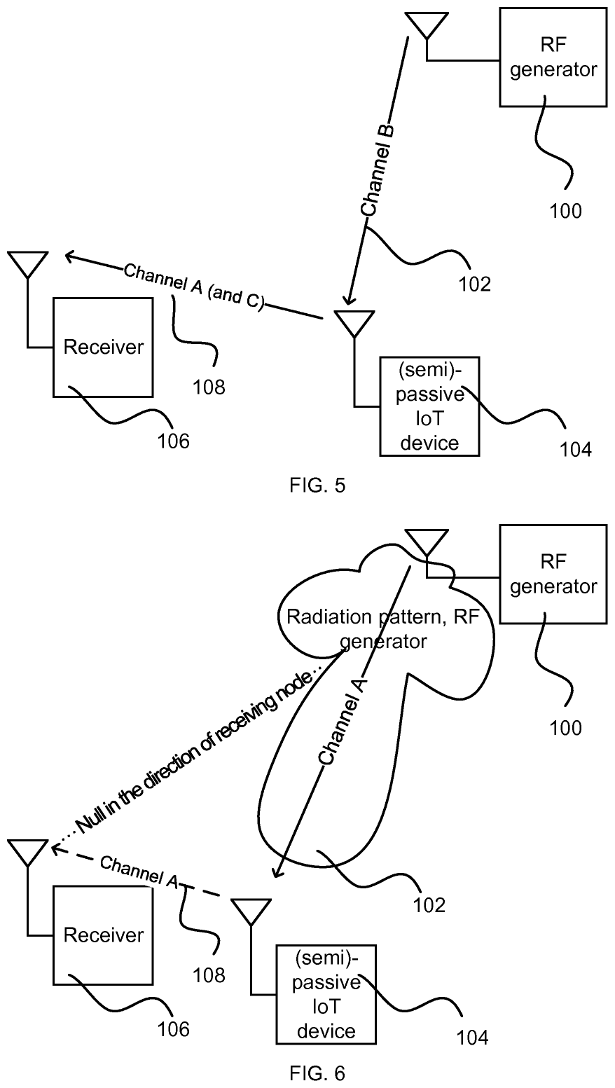

Returning to FIG. 3, where the upper diagram illustrates a power to frequency diagram for the RF signal 102, here noted as being on channel B, and the lower diagram illustrates a power to frequency diagram for the retransmitted signal 108, here noted as being on channels A and C, we now turn to FIG. 5, which illustrates a similar setup as the one illustrated in FIG. 1, and the same reference numerals for the elements are used for the sake of easier understanding. The RF generator 100 for example provides the RF signal 102 on channel B which by the switching frequency is modulated and retransmitted on channel A and C as signal 108. The receiver 106 may then for example receive the information on channel A. The receiver 106 is a legacy receiver, e.g. a WiFi access point or station. The RF generator 100 may for example operate as a WiFi access point. Other access technologies may be equally feasible. As elucidated above, one problem is when using unlicensed spectrum and LBT is applied. Therefore, the most important other access technologies in mind are for example Long Term Evolution (LTE) in unlicensed band such as LTE-Unlicensed (LTE-U), Licensed Assisted Access (LAA), MulteFire, etc., and wireless personal and local area network (PAN, LAN) technologies.

Similarly, returning to FIG. 4, where the upper diagram illustrates a power to frequency diagram for the RF signal 102 and the lower diagram illustrates a power to frequency diagram for the retransmitted signal 108 on the same channel B, we now turn to FIG. 6 which illustrates a way of avoiding self-induced interference by the system is that the radiating entity 100, which provides the incoming RF signal 102 towards the backscattering device 104, provides the signal towards the backscattering device 104 while limiting the signal in other directions, particularly in the direction of a receiver 106 of the backscattered signal 108. This can be accomplished by beamforming for example as illustrated in FIG. 6. Other ways to accomplish this is by wisely locating the radiating entity 100 such that signals are attenuated in directions towards potential receivers where the signal may cause interference.

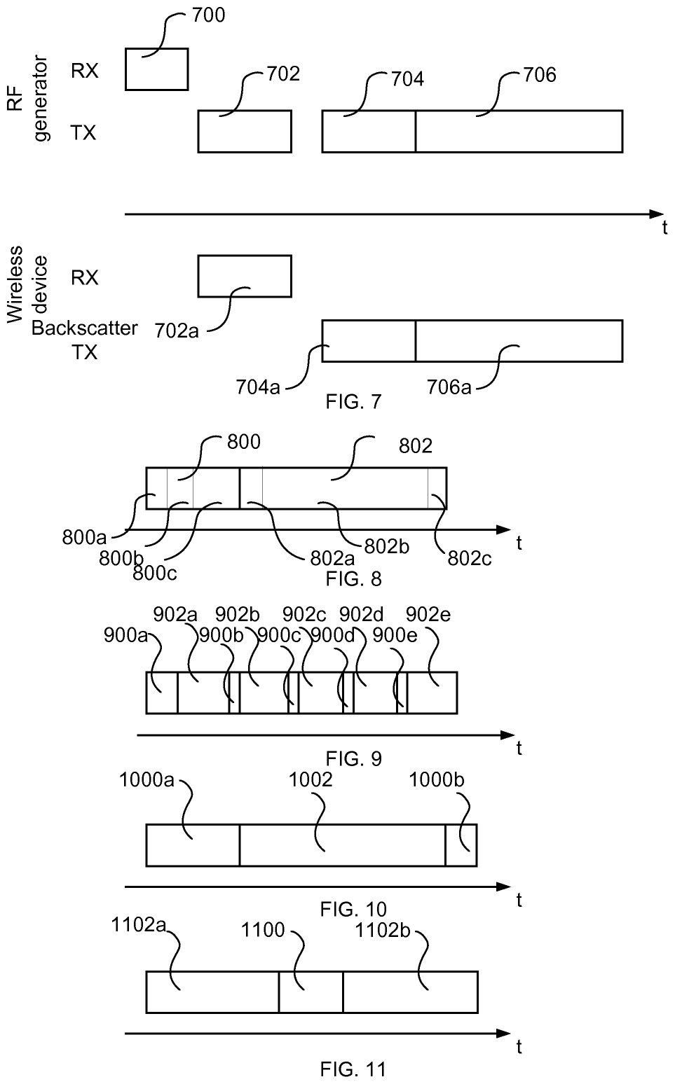

With these options and the gist of the invention in mind, i.e. to let the RF generating entity 100 do some tasks on behalf of the wireless device 104 to perform processing tasks, e.g. forming of OFDM symbols, decrease energy consumption in the wireless device 104, etc., such that probability that other stations defer the medium, e.g. by enabling decoding of a part of the transmission, which may gain 20 dB as elucidated above, without requiring some complex tasks, to be performed by the wireless device 104, we now turn to FIG. 7 which is a timing and signal diagram for the RF generator 100 (above the time line) and the wireless device 104 (below the time line). For respective entity, signals are divided in the diagram into received and transmitted signals. Benefits may be reduced complexity of the wireless device (104) and/or reduced energy consumption in the wireless device (104).

One task on which the RF device 100 may aid the wireless device 104 is to determine whether the channel is clear to use, often referred to as Clear Channel Assessment (CCA), which is a part of the LBT approach. Thus, the RF generator 100 may listen 700 for signals on the channel on which the wireless device 100 is about to transmit on. Here, depending on whether the RF generator 100 is transmitting on the same channel as the wireless device 104 or not, as discussed above with reference to FIGS. 3 to 6, the RF generator may need to check more than one channel when doing the CCA 700. If the channel or channels are free, the RF generator 100 transmits a command 702 to the wireless device 104 about the upcoming transmission. Thus, the wireless device 104 receives the command 702a.

Here, it should be noted that under some circumstances, the wireless device 104 is not obliged to perform CCA, and in such cases, the aid from the RF device 100 is not necessary.

Another task on which the RF device 100 aids the wireless device 104 is to prepare and send a ready to retransmit part (704) of the transmission that the wireless device 104 is to transmit as a purely retransmitted part (704a). This can for example be a preamble, midamble, postamble, control signals, reference signals, etc. which the RF generator 100 fully knows and can prepare. The wireless device 104 can thus retransmit the prepared part (704) without altering any of its information to provide the retransmitted part (704a). This can be made by pure reflection, i.e. the antenna arrangement 200 is connected to one of the impedances 204 by the switching arrangement 202 and the impedance is kept constant such that the pure reflection is achieved. Alternatively, it is made by retransmission on another frequency where the switching is applied such that the transmitted signal 108 becomes like illustrated in FIG. 3, but still no information is altered.

This task provides one or more benefits. One is that complexity of the wireless device 104 may be kept low, e.g. not needing processing capabilities for forming OFDM symbols, and still be able to co-exist with other devices, including more complex devices, sharing the spectrum.

As demonstrated above, the RF device 100 also provides another part of its transmission which the wireless device 104 is arranged to modulate and provide information to the receiver device 106. In FIG. 7, this is illustrated as the transmission 706 from the RF generator 100 which is keyed and retransmitted 706a by the wireless device 104. Some examples of transmissions from the wireless device 104 will be discussed with reference to FIGS. 8 to 11.

By the aid from the RF generator with a first part which is ready to be retransmitted without keying and a second part which the wireless device can key to provide its information to the receiver device 106, the complexity of the wireless device can be kept low and/or energy may be saved in the wireless device, which makes it particularly suitable for IoT applications where low or ultra-low energy consumption is desired. Although the above stated benefits, proper co-existence with other wireless devices using other radio access technologies, e.g. broadband WiFi, LTE for unlicensed band, etc., is facilitated.

FIG. 8 is a signal timing diagram which illustrates a transmission comprising a preamble 800 and a main part 802. The preamble 800 is received from the RF generator 100 and just retransmitted to the receiver device 106. The preamble 800 may for example comprise a Short Training Field (STF) 800a, a Long Training Field (LTF) 800b, and a signal field 800c which may comprise transmission parameters. The main part 802 may comprise a service field 802a, a data field 802b, and a tail field 802c. The main part 802 is formed by keying by the wireless device 104 where the baseband signal generator 206 controls the switching arrangement 202 to form the main part 802. This example may for example be applicable for co-existence with WiFi devices.

FIG. 9 is a signal timing diagram which illustrates a transmission comprising a first part 900a-e and a second part 902a-e. The first part 900a-e is distributed over the transmission and is received from the RF generator 100 and just retransmitted to the receiver device 106. The first part 900a-e may for example comprise a header 900a and a plurality of reference and/or control signals 900b-e which are to be periodically provided during the transmission. The second part 902a-e is interspersed with the first part 900a-e and is keyed by the wireless device 104. This example may for example be applicable for some LTE flavour for unlicensed spectrum.

FIG. 10 is a signal timing diagram which illustrates a transmission comprising a first part 1000a-b and a second part 1002. The first part 1000a-b comprises a preamble 1000a and a postamble 1000b.

FIG. 11 is a signal timing diagram which illustrates a transmission comprising a first part 1100 and a second part 1102a-b. The first part 1100 comprises a midamble. The second part 1102a-b comprises a part 1102a prior the midamble 1100 and a part 1100b after the midamble.

These latter examples may for example be applicable for different PAN or LAN technologies. Further examples including features of two or more of the examples demonstrated with reference to FIGS. 8 to 11 are equally feasible, and for the sake of brevity not detailed here since the skilled reader would readily contemplate them from the teachings given above.

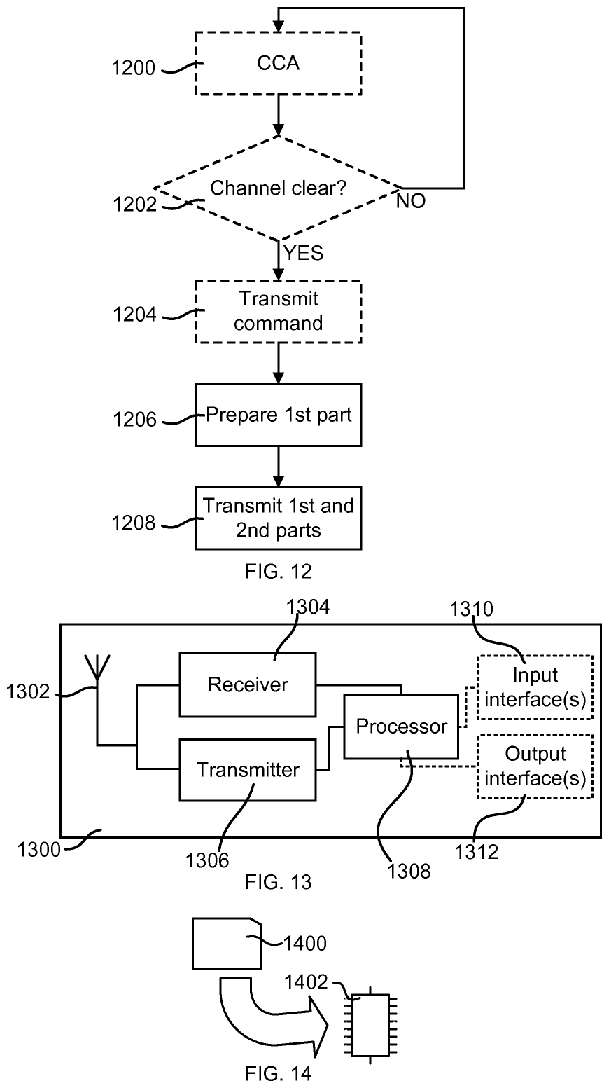

FIG. 12 is a flow chart schematically illustrating a method for a RF generator, which for example may be an access point, a base station, or other network node, or a dedicated RF generator device. The method comprises actions for aiding a wireless device to be able to operate according to a backscattering approach, but also aiding the wireless device to enable further energy savings in the wireless device by performing some actions on behalf of the wireless device.

The method may include to make CCA 1200 on behalf of the wireless device, and if the channel is not clear 1202; NO, a new attempt is made at a later instant, according to applied LBT procedure. If the channel is clear 1202; YES, the RF generator sends 1204 a transmit command to the wireless device and prepares 1206 a first part, i.e. the pre-prepared part elucidated above which the wireless device just can retransmit without keying, which suits for the transmission to be performed by the wireless device.

As discussed above, the CCA may be omitted for the wireless device under certain circumstances, wherein this part of the aid by the RF generator may be omitted. In such cases, the RF generator just prepares 1206 the first part.

When it is time for the transmission, e.g. after an interframe space or at a suitable time slot, the RF generator transmits 1208 the first part and a second part, i.e. the second part which the wireless device is to key to transmit information, according to the format which the wireless device is to make its transmission, e.g. as any of the examples demonstrated with reference to FIGS. 8 to 11.

FIG. 13 is a block diagram schematically illustrating a RF generator 1300 according to an embodiment. The RF generator 1300, which for example may be an access point, a base station, or other network node, or a dedicated RF generator device, comprises an antenna arrangement 1302, a receiver 1304 connected to the antenna arrangement 1302, a transmitter 1306 connected to the antenna arrangement 1302, a processing element 1308 which may comprise one or more circuits, one or more input interfaces 1310 and one or more output interfaces 1312. The interfaces 1310, 1312 can be operator interfaces and/or signal interfaces, e.g. electrical or optical. The RF generator 1300 may be arranged to operate in an unlicensed spectrum where LBT is applied, and is arranged to aid a backscattering wireless device as demonstrated above. In particular, by the processing element 1308 being arranged to perform the embodiments demonstrated with reference to FIGS. 1 to 12, the RF generator 1300 is capable of aiding the wireless device to have reduced complexity and/or decrease energy consumption and provide proper co-existence with other more complex devices, e.g. broadband WiFi devices or LTE devices for unlicensed spectrum. The processing element 1308 can also fulfill a multitude of tasks, ranging from signal processing to enable reception and transmission since it is connected to the receiver 1304 and transmitter 1306, executing applications, controlling the interfaces 1310, 1312, etc.

The methods according to the present invention are suitable for implementation with aid of processing means, such as computers and/or processors, especially for the case where the processing element 1308 demonstrated above comprises a processor handling the preparation of the first part of the transmission for the wireless device as demonstrated above, and to coordinate the transmission on behalf of the wireless device. Therefore, there is provided computer programs, comprising instructions arranged to cause the processing means, processor, or computer to perform the steps of any of the methods according to any of the embodiments described with reference to FIG. 1 to 13. The computer programs preferably comprise program code which is stored on a computer readable medium 1400, as illustrated in FIG. 14, which can be loaded and executed by a processing means, processor, or computer 1402 to cause it to perform the methods, respectively, according to embodiments of the present invention, preferably as any of the embodiments described with reference to FIGS. 1 to 13. The computer 1402 and computer program product 1400 can be arranged to execute the program code sequentially where actions of the any of the methods are performed stepwise, or be arranged to perform actions on a real-time basis. The processing means, processor, or computer 1402 is preferably what normally is referred to as an embedded system. Thus, the depicted computer readable medium 1400 and computer 1402 in FIG. 14 should be construed to be for illustrative purposes only to provide understanding of the principle, and not to be construed as any direct illustration of the elements.

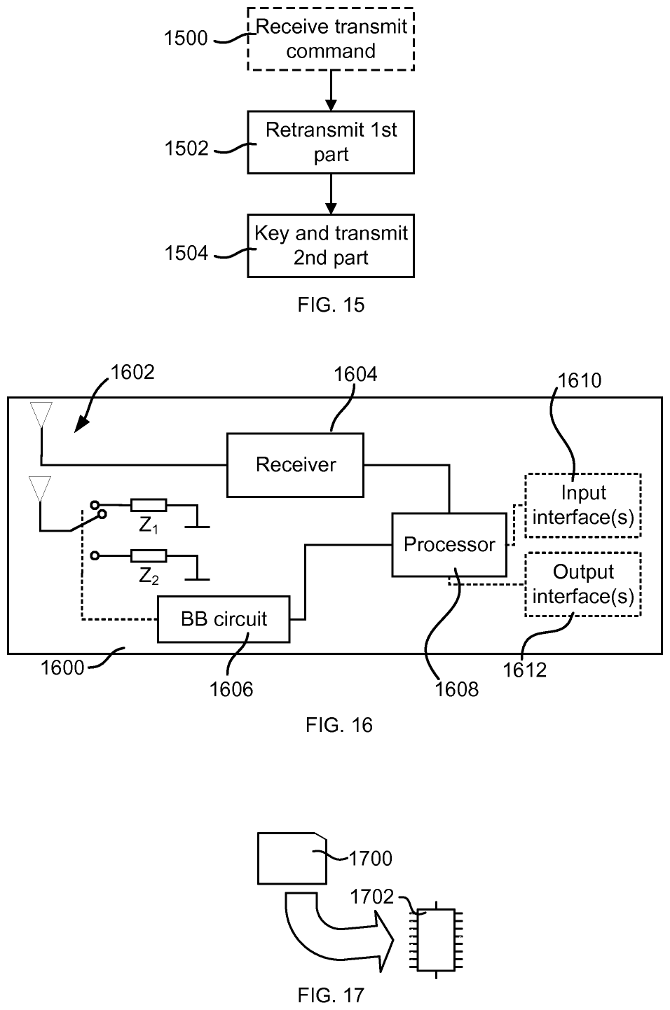

FIG. 15 is a flow chart schematically illustrating a method for a wireless device, which for example may be an IoT device, arranged for backscattering transmission and suitable for operating together with an RF generator as demonstrated above. The method comprises, as can be seen from the tiny FIG. 15, few actions which is possible due to aid from the RF generator to enable further energy savings than normally associated with backscattering devices.

The method may include to receive 1500 a transmit command from the RF generator. Thus, the wireless does not need to spend energy on making CCA since the RF generator has performed that on behalf of the wireless device. As demonstrated above, the CCA is not necessary in some conditions, wherein that part is omitted. When it is time for the transmission, e.g. after an interframe space or at a suitable time slot, the wireless device retransmits 1502 a first part without keying, and keys and retransmits 1504 a second part by backscattering a signal received from the RF generator which transmits the first part and the second part, i.e. the first part which is pre-prepared by the RF generator to just be retransmitted without keying and the second part which the wireless device is to key to transmit information. The parts are prepared according to the format which the wireless device is to make its transmission, e.g. as any of the examples demonstrated with reference to FIGS. 8 to 11, by the RF generator, wherein the wireless device only needs to spend very little energy on the transmission forming. It is more or less only payload which needs to be processed.

FIG. 16 is a block diagram schematically illustrating a wireless device 1600 according to an embodiment. The wireless device 1600, which for example may be an IoT device, arranged for backscattering transmission and suitable for operating together with an RF generator as demonstrated above, comprises an antenna arrangement 1602, a receiver 1604 connected to the antenna arrangement 1602, a transmitter 1606 connected to the antenna arrangement 1602, a processing element 1608 which may comprise one or more circuits, one or more input interfaces 1610 and one or more output interfaces 1612. The transmitter 1606 is provided by a baseband circuit arranged to control a switch, as demonstrated with reference to FIG. 2, such that the wireless device makes transmissions by backscattering of an incoming RF signal. The interfaces 1610, 1612 can be operator interfaces and/or signal interfaces, e.g. electrical or optical. The wireless device 1600 is arranged to operate in an unlicensed spectrum where LBT is applied, and is arranged to transmit by backscattering as demonstrated above. Thus, by aid from the RF generator, the wireless device is suitable for low-power or ultra-low-power applications, but is still capable of interacting with a legacy receiver 106 as discussed above. In particular, by the processing element 1608 being arranged to perform the embodiments demonstrated with reference to FIGS. 1 to 12, the wireless device 1600 is capable of being aided by the RF generator which provides for the very low energy consumption. The processing element 1608 can also fulfill a multitude of tasks, ranging from signal processing to enable reception and transmission since it is connected to the receiver 1604 and transmitter 1606, executing applications, controlling the interfaces 1610, 1612, etc.

The methods according to the present invention are suitable for implementation with aid of processing means, such as computers and/or processors, especially for the case where the processing element 1608 demonstrated above comprises a processor handling to coordinate the retransmission of the first part of the transmission as demonstrated above, and keying and retransmitting the second part. Therefore, there is provided computer programs, comprising instructions arranged to cause the processing means, processor, or computer to perform the steps of any of the methods according to any of the embodiments described with reference to FIG. 1 to 13. The computer programs preferably comprise program code which is stored on a computer readable medium 1700, as illustrated in FIG. 17, which can be loaded and executed by a processing means, processor, or computer 1702 to cause it to perform the methods, respectively, according to embodiments of the present invention, preferably as any of the embodiments described with reference to FIGS. 1 to 13. The computer 1702 and computer program product 1700 can be arranged to execute the program code sequentially where actions of the any of the methods are performed stepwise, or be arranged to perform actions on a real-time basis. The processing means, processor, or computer 1702 is preferably what normally is referred to as an embedded system. Thus, the depicted computer readable medium 1700 and computer 1702 in FIG. 17 should be construed to be for illustrative purposes only to provide understanding of the principle, and not to be construed as any direct illustration of the elements.

1. A system comprising:
a network node;
a wireless device; and
a receiving device, wherein
the network node is arranged to support the wireless device,
the wireless device is arranged for passive or semi-passive radio transmissions,
the network node is arranged to provide a radio frequency (RF) signal towards the wireless device, wherein the RF signal comprises a first part and a second part,
the first part is configured for being purely retransmitted by backscattering by the wireless device, and
the second part is configured for backscattering keying by the wireless device to convey data from the wireless device to the receiving device.

2. The system of claim 1, wherein the network node is arranged to perform clear channel assessment (CCA) on behalf of the wireless device and, upon a clear channel, provide the radio frequency RF signal towards the wireless device.

3. The system of claim 1, wherein the first part is configured for keeping channel protected in view of clear channel assessment (CCA) by other entities by enabling decoding of the first part by the other entities.

4. The system of claim 3, wherein the first part comprises orthogonal frequency division multiplex (OFDM) symbols and the backscattered second part comprises symbols keyed with lower complexity enabled by the backscattering keying:

5. The system of claim 4, wherein the symbols keyed with the lower complexity are keyed with any one of:
on-off keying;
amplitude shift keying;
frequency shift keying; and
phase shift keying.

6. The system of claim 1, wherein the first part comprises one or more of:
a preamble;
a midamble;
a postamble;
reference signals; and
synchronisation signals.

7. The system of claim 1, wherein the first part is distributed over a duration of the RF signal and the second part is interspersed with the first part.

8. The system of claim 1, wherein the first part is provided at an uninterrupted part of the RF signal and the second part is provided over a rest of a duration of the RF signal.

9. The system of claim 1, wherein the RF signal is transmitted at a first frequency on which the wireless device is expected to perform its transmissions towards the receiving device.

10. The system of claim 9, wherein the network node is arranged to direct the RF signal towards the wireless device and attenuate the RF signal towards the receiving device.

11. The system of claim 1, wherein the wireless device is expected to perform its transmissions towards the receiving device at a first frequency, and the network node is arranged to transmit the RF signal at a second frequency with an offset defined by the backscattering by the wireless device to the first frequency.

12. The system of claim 1, wherein the first part is further configured for including transmission parameters on behalf of the wireless device.

13. The system of claim 12, wherein the transmission parameters comprise any of:
control field;
address information; and
duration of transmission.

14. A network node arranged to support a wireless device, which wireless device is arranged for passive or semi-passive radio transmissions, and to provide a radio frequency (RF) signal towards the wireless device, wherein the RF signal comprises a first part and a second part, where the first part is configured for being purely retransmitted by backscattering by the wireless device, and the second part is configured for backscattering keying by the wireless device to convey data from the wireless device.

15. The network node of claim 14, further arranged to perform clear channel assessment (CCA) on behalf of the wireless device and, upon a clear channel, provide the radio frequency (RF) signal towards the wireless device.

16. The network node of claim 14, wherein the first part is configured for keeping channel protected in view of clear channel assessment (CCA) by other entities by enabling decoding of the retransmitted first part by the other entities.

17. The network node of claim 16, wherein the first part comprises orthogonal frequency division multiplex (OFDM) symbols.

18. The network node of claim 14, wherein the first part comprises one or more of:
a preamble;
a midamble;
a postamble;
reference signals; and
synchronisation signals.

19. The network node of claim 14, wherein the first part is distributed over a duration of the RF signal and the second part is interspersed with the first part.

20. The network node of claim 14, wherein the first part is provided at an uninterrupted part of the RF signal and the second part is provided over a rest of a duration of the RF signal.

21. The network node of claim 14, wherein the RF signal is transmitted at a first frequency on which the wireless device is expected to perform its transmissions towards a receiver.

22. The network node of claim 21, arranged to direct the RF signal towards the wireless device and attenuate the RF signal towards the receiver.

23. The network node of claim 14, wherein the wireless device is expected to perform its transmissions towards a receiver at a first frequency, and the network node is arranged to transmit the RF signal at a second frequency with an offset defined by the backscattering by the wireless device to the first frequency.

24. The network node of claim 14, wherein the first part is further configured for including transmission parameters on behalf of the wireless device.

25. The network node of claim 24, wherein the transmission parameters comprise any of:
control field;
address information; and
duration of transmission.

26. (canceled)

27. A method of a network node arranged to support a wireless device, which wireless device is arranged for passive or semi-passive radio transmissions, the method comprising:
preparing a radio frequency (RF) signal which comprises a first part and a second part, where the first part is configured for being purely retransmitted by backscattering by the wireless device, and the second part is configured for backscattering keying by the wireless device to convey data from the wireless device; and
transmitting the radio frequency (RF) signal towards the wireless device.

28. The method of claim 27, comprising:
performing clear channel assessment (CCA) on behalf of the wireless device; and
upon a clear channel, enabling the transmitting of the radio frequency (RF) signal towards the wireless device.

29. The method of claim 27, wherein the first part is configured for keeping channel protected in view of clear channel assessment (CCA) by other entities by enabling decoding of the retransmitted first part by the other entities.

30. The method of claim 29, wherein the first part comprises orthogonal frequency division multiplex (OFDM) symbols.

31. The method of claim 27, wherein the RF signal is transmitted at a first frequency on which the wireless device is expected to perform its transmissions towards a receiver, the method comprising:
directing the RF signal towards the wireless device; and
attenuating the RF signal towards the receiver.

32. The method of claim 27, wherein the first part is further configured for including transmission parameters on behalf of the wireless device.

33. The method of claim 32, wherein the transmission parameters comprise any of:
control field;
address information; and
duration of transmission.

34. A non-transitory computer readable storage medium comprising instructions which, when executed on a processor of a network node, cause the network node to perform a method, wherein the network node is arranged to support a wireless device, which wireless device is arranged for passive or semi-passive radio transmissions, and wherein the method comprises:
preparing a radio frequency (RF) signal which comprises a first part and a second part, where the first part is configured for being purely retransmitted by backscattering by the wireless device, and the second part is configured for backscattering keying by the wireless device to convey data from the wireless device; and
transmitting the radio frequency (RF) signal towards the wireless device.

35. A wireless device arranged for passive or semi-passive radio transmissions by backscattering an incoming radio frequency (RF) signal, which RF signal comprises a first part and a second part, where wireless device is arranged to purely retransmit the first part by backscattering, and configured to key backscattering of the second part to convey data from the wireless device.

36. The wireless device of claim 35, wherein the first part is configured for keeping channel protected in view of clear channel assessment (CCA) by other entities by enabling decoding of the first part by the other entities.

37. The wireless device of claim 36, wherein the retransmitted first part comprises orthogonal frequency division multiplex (OFDM) symbols and the backscattered second part comprises symbols keyed with lower complexity enabled by the backscattering keying.

38. The wireless device of claim 37, wherein the symbols keyed with the lower complexity are keyed with any one of:
on-off keying;
amplitude shift keying;
frequency shift keying; and
phase shift keying.

39. The wireless device of claim 35, wherein the first part comprises one or more of:
a preamble;
a midamble;
a postamble;
reference signals; and
synchronisation signals,
wherein the wireless device is arranged to adapt timing of the keying of the second part based on any of the signals of the first part.

40. The wireless device of claim 35, wherein the first part is distributed over a duration of the RF signal and the second part is interspersed with the first part.

41. The wireless device of claim 35, wherein the first part is provided at an uninterrupted part of the RF signal and the second part is provided over a rest of a duration of the RF signal.

42. The wireless device of claim 35, wherein the RF signal is transmitted at a first frequency on which the wireless device is expected to perform its transmissions towards a receiver, wherein the wireless device is arranged to keep impedances for the backscattering constant during the first part.

43. The wireless device of claim 35, wherein the wireless device is expected to perform its transmissions towards a receiver at a first frequency, and the RF signal has a second frequency with an offset to the first frequency, wherein the wireless device is arranged to switch impedances for the backscattering with a third frequency to achieve retransmission at the first frequency.

44. The wireless device of claim 35, wherein the first part is further configured for including transmission parameters on behalf of the wireless device.

45. The wireless device of claim 44, wherein
the transmission parameters comprise any of:
control field;
address information; and
duration of transmission.

46. A method of a wireless device arranged for passive or semi-passive radio transmissions by backscattering an incoming radio frequency (RF) signal, which RF signal comprises a first part and a second part, the method comprising:
purely retransmitting the first part by backscattering; and
keying and transmitting by backscattering the second part.

47. The method of claim 46, wherein the retransmitted first part is configured for keeping channel protected in view of clear channel assessment (CCA) by other entities by enabling decoding of the first part by the other entities.

48. The method of claim 47, wherein the retransmitted first part comprises orthogonal frequency division multiplex (OFDM) symbols and the backscattered second part comprises symbols keyed with lower complexity enabled by the backscattering keying.

49. The method of claim 48, wherein the symbols keyed with the lower complexity are keyed with any one of:
on-off keying;
amplitude shift keying;
frequency shift keying; and
phase shift keying.

50. The method of claim 46, wherein the RF signal is at a first frequency on which the wireless device is expected to perform its transmissions towards a receiver, the method comprising keeping impedances for the backscattering constant during the first part.

51. The method of claim 46, wherein the wireless device is expected to perform its transmissions towards a receiver at a first frequency, and the RF signal has a second frequency with an offset to the first frequency, the method comprising switching impedances for the backscattering with a third frequency to achieve retransmission at the first frequency.

52. The method of claim 46, wherein the first part is further configured for including transmission parameters on behalf of the wireless device.

53. The method of claim 52, wherein the transmission parameters comprise any of:
control field;
address information; and
duration of transmission.

54. A non-transitory computer readable storage medium comprising instructions which, when executed on a processor of a wireless device, causes the wireless device to perform a method, wherein the wireless device is arranged for passive or semi-passive radio transmissions by backscattering an incoming radio frequency (RF) signal, which RF signal comprises a first part and a second part, wherein the method comprises:
purely retransmitting the first part by backscattering; and
keying and transmitting by backscattering the second part.
